(19) United States
(12) Patent Application Publication
(10) Pub. No.: US 2002/0079414 A1
(43) Pub. Date: Jun. 27, 2002

(54) Structure of supporting frame for heater lamp in e-beam evaporator

(75) Inventors: Hua-Jen Tseng, Hsinchu (TW); Chun-Chieh Lee, Hsinchu (TW); Kung-Wei Cheng, Hsinchu (TW); Hung-Lin Ke, Hsinchu (TW)

Correspondence Address: BACON & THOMAS, PLLC, 625 SLATERS LANE, FOURTH FLOOR, ALEXANDRIA, VA, 22314

(73) Assignee: Mosel Vitelic Inc., Hsinchu (TW)

(21) Appl. No.: 10/014,596

(22) Filed: Dec. 14, 2001

(30) Foreign Application Priority Data
Dec. 27, 2000 (TW) 89128064

(51) Int. Cl. A47K 1/00; F16L 3/08; E04G 5/06

(52) U.S. Cl. 248/222.14

(57) ABSTRACT

A structure of supporting frame for heater lamp in evaporator is disclosed. The supporting frame contains a lower supporting frame and an upper supporting female, respectively, by means of a non-circle section on the male portion and a complementary section on the female portion to conjoin together and to restrain them to rotate. Consequently, the proposed supporting frame provides directly locating during the female joint step of male portion and female portion. The time consuming steps for e-beam evaporator maintain are thus omitted.

### FIELD OF THE INVENTION

The present invention relates to a supporting frame for heater lamp in evaporator, especially to a conjunction improvement between two supporting members so as to make the heater lamp locating and maintain easily and conveniently.

### BACKGROUND OF THE INVENTION

Currently, a generally application of the e-beam evaporator is to deposit a thin metal film, such as a film of titanium, nickel, or silver etc., by using electron beam illuminating the target source to a vapor state and then adhering to a wafer or something the like, which is supported by a substrate carrier. Before depositing, the substrate carrier is usually preheated to a predetermined temperature (typically about 200° C.) until outgas phenomena to occur from the substrate carrier and the chamber wall. The outgas process is to ensure the target with a clear surface and the vacuum chamber with a high degree of vacuum. Consequently, for those purposes, inside e-beam evaporator, several heater lamps are usually installed therein to make substrate carrier having a predetermined temperature evenly, so that the thin film can be deposited uniformly.

Please refer to FIG. 1, a plurality of the heat lamps 2 (three heat lamps are shown) are equipped at the chamber wall of the e-beam evaporator 1. The heater lamps 2 are equipped on a shielding plate 3, which is inside a housing space of the e-beam evaporator 1. To alleviate the heater lamp 2 affect the operable space, the heater lamps 2 are usually installed at positions near the chamber wall.

Referring to FIG. 2, a stereo-explode diagram of the heater lamp is shown. In FIG. 2, a lower supporting frame 21, an upper supporting frame 22 and a heater lamp body 23 are shown. The heater lamp body 23 is equipped atop the supporting frame 22 and the upper portion of the lower supporting frame 21 has external thread 211 for matching with the tapped hole 221 of the upper frame 22. Two members 21,22 joining together are implemented though a hole 31 of the shielding plate 3.

To avoid the chamber suffering from the particulate contamination due to the shielding plate 3, the shielding plate 3 has to be replaced timely to a new one. As shown in FIG. 1 and FIG. 2, an operator screws the upper supporting frame 22 off the lower supporting frame 21 so that he can take the shield plate 3 away from the upper supporting frame 22. Consequently, the impact between the heater lamp body 23 and the chamber wall 10 could be avoided as the heater lamp body 23 rotates with the upper supporting frame while the upper supporting frame 22 are separated from the lower supporting frame 21.

In a conventional e-beam evaporator, its heating operation all relies on the heater lamp 2 to proceed. For sake of assuring the wafer and some things the like on the substrate carrier having a good deposited effect as well as in the correct operating temperature, the forgoing conventional heater lamp 2 fixed by the thread when it is installed, the altitude, the orientation and the angle of elevation all need to be taken carefully. On the other aspect, due to the shielding plate 3 replaced or the other maintaining operation, the heater lamp 2 needs to be disassembly firstly, and then reassembled. Therefore, for assuring that the heater lamps 2 are installed with a correct altitude, orientation, and the angle of elevation, an uniform temperature process has to be run once again after its maintenance. However, an uniform temperature correcting procedure is a time consuming severe step, it usually needs spend about 2-3 hours and above, as a result, influences the cycle time.

### SUMMARY OF THE INVENTION

An object of the present invention is to provide a supporting frame, which contains a lower supporting frame and an upper supporting female, respectively by means of a non-circle section on the male portion and a complementary section on the female portion to conjoin together and to restrain them rotated relatively.

In a preferred embodiment, the non-circle section is a pillar section and with a flat edge. By means of female portion with a correspondent profile, they can be conjoined together and the relative rotation is restrained.

In the invention, the cross-section of the non-circle section can be a square shape, a circle but with a flat edge, a hexagonal shape, or a something like.

Furthermore, the male portion contains a protruding key, and the female portion contains a key way to provide the protruding key to pass. The key way can be formed inside the sidewall of the female portion without or through the sidewall laterally.

Still a preferred embodiment, the male portion is a pillar with a key hole in the non-circle section and the female portion contains a penetration hole corresponding to the key hole so that when they are of female joint, those holes form a key way to provide a key-pin inserted thereby fixing. By means of them, the relative rotation between female portion and male portion are constrained.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1. is a synoptic layout for the heat lamp in the e-beam evaporator.

FIG. 2. is a stereo-explode diagram of a supporting frame for the heater lamp in accordance with the prior art.

FIG. 3. is a stereo-explode diagram of a supporting frame for the heater lamp in accordance with the present invention.

FIG. 4A is a first cross-section view of the non-circle section in accordance with a first preferred embodiment of the present invention.

FIG. 4B is a second cross-section view of the non-circle section in accordance with the present invention.

FIG. 4C is a third cross-section view of the non-circle section in accordance with the present invention.

FIG. 4D is a fourth cross-section view of the non-circle section in accordance with the present invention.

FIG. 4E is a fourth cross-section view of the non-circle section in accordance with the present invention.

FIG. 5 is a supporting frame structure in accordance with a second preferred embodiment of the present invention.

FIG. 6 is a supporting frame structure in accordance with a third preferred embodiment of the present invention.

FIG. 7 is a supporting frame structure in accordance with a fourth preferred embodiment of the present invention.

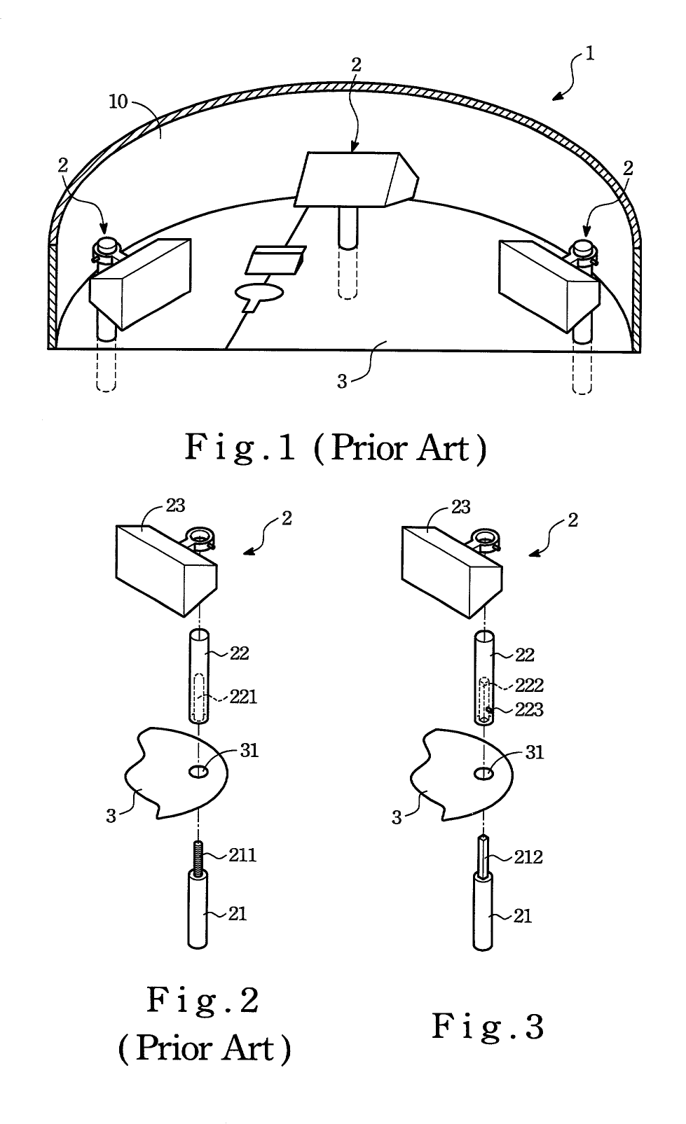

### DETAILED DESCRIPTION OF THE PREFERRED EMBODIMENT

As forgoing prior art, the joint of the supporting frame of the heater relies on the thread. It thus has to disassemble the heater lamp when the shielding plate is replaced. As a result, as the heater lamp reassembled, the altitude, and orientation both require locating. Furthermore, the time consuming step of about uniform temperature correction need to be done.

Thus, the present invention is to improve the joint of supporting frame for the heater lamps.

FIG. 3 shows a stereo-explode diagram of supporting frame and heater lamp in an e-beam evaporator. Similar to the conventional heater lamp 2 structures, the heater lamp 2 is the same as conventional heater lamp. The differences between FIG. 2 and FIG. 3 are: the upper supporting frame 22 and lower supporting frame 21 rely on the thread conjunction as is shown in FIG. 2. However, as shown in FIG. 3 in accordance with a preferred embodiment of the present invention, the conjunction of the upper supporting frame 22 and lower supporting frame 21 is in terms of an mating pair. The improvement is without rotating operation. Consequently, when the shielding plate 3 is replaced, the heater lamp body 23 has not to disassemble the upper supporting frame 22. Therefore the altitude, the orientation adjustment during the reassembling step can be skipped, and omit the time consuming step of about uniform temperature.

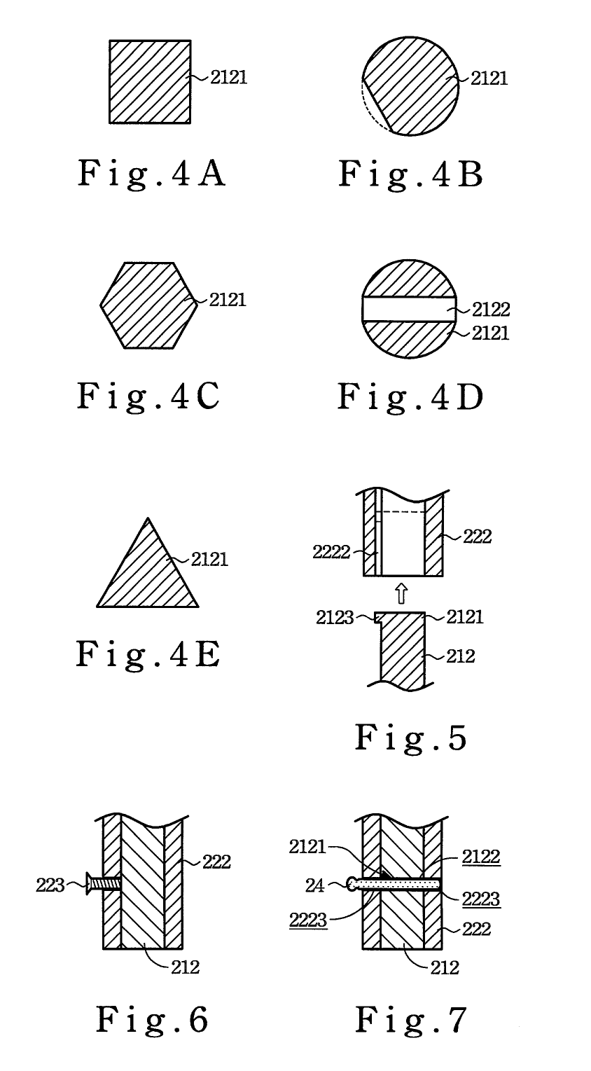

Still referring to FIG. 3, the mating pair includes a male portion 212 protruded on the upper portion of the lower supporting frame 21 and a female portion 222 formed on the lower portion of the upper supporting frame 22. The male portion 212 contains a non-circle section 2121. The female portion 222 is to female join the male portion, as is shown in the figure. In a preferred embodiment, the non-circle section 2121 is with a square cross-section, as is shown in FIG. 4A. Correspondently, the female portion has a complementary hole so that both the female portion and the male portion can form a female joint. Accordingly, the relative rotation between the male portion 212 and female portion is restricted.

As is shown in FIG. 3 and FIG. 6, the upper supporting frame 212 further comprises a screw stop 223 to press the female portion 212 to the male portion 212 through a sidewall of the female portion 212 while they are of female joint.

Preferably, the non-circle section 2121 can be of all parts of male portion or a part of the male portion 212 only. In addition to aforementioned square shape (please see FIG. 4A), the cross-section of the non-circle can be a circle but with a flat edge (please see FIG. 4B), or a hexagonal shape (please see FIG. 4C), or a triangle shape (please see FIG. 4E), or something the like, which is with a flat edge. Surely, as the non-circle section of the male portion 212 is selected and has a cross-section as depicted above, the female portion 222 has to be trimmed with a complementary profile to the male portion 212 so as to form a mechanism restricted the relative rotation.

FIG. 5 shows an explode diagram of the supporting frame of another embodiment. The non-circle section of the male portion 212 contains a protruding key 2123, and the female portion 222 contains a key way 2222 to mate the male portion 212. The key way 2222 can be formed inside the sidewall of the female portion without or through the sidewall laterally.

FIG. 7 illustrates the supporting frame structure after the male portion and the female portion are conjoined in accordance with still another preferred embodiment. The non-circle section of the male portion 212 is a pillar section with a key-hole 2122 (please see FIG. 4D, the cross-sectional view) and the female portion 222 contain a perforated hole 2223, which corresponds to the key hole 2122 of the male portion 212. By means of those hole 2123, 2122, the male portion 212 and female portion 222 can be of female joint while they are locating and form a keyway to provide a key-pin to fix them. Thus, the relative rotation of male portion 212 to the female portion 222 is constrained.

In the preferred embodiment, the profile of the non-circle section of the male portion 212 can be made by a cylindrical pillar, a square pole or other appropriate pillar so as to facilitate manufacture.

The benefits of the present invention are:

The supporting frame of the heater lamp requires directly inserting the male portion into the female portion only. Joining the lower supporting frame to the upper supporting frame provides heater lamp a locating function in accordance with the present invention and thus easily to maintain.

As is understood by a person skilled in the art, the foregoing preferred embodiment of the present invention is an illustration of the present invention rather than limiting thereon. It is intended to cover various modifications and similar arrangements included within the spirit and scope of the appended claims, the scope of which should be accorded the broadest interpretation so as to encompass all such modifications and similar structure.

What is claimed is:

1. A structure of supporting frame for heater lamp in evaporator comprising:
a lower supporting frame, having a male portion at an end thereof, said male portion being a non-circle section; and
an upper supporting frame having a female portion at an end therefrom mating with said male portion and giving a rotation restraint to said male portion.

2. The supporting frame according to claim 1, wherein said non-circle section is a pillar section, further, said pillar section has at least one flat edge profile.

3. The supporting frame according to claim 1, wherein said non-circle section is a pillar section with a square cross-section.

4. The supporting frame according to claim 1, wherein said non-circle section is a pillar section with a triangle cross-section.

5. The supporting frame according to claim 1, wherein said non-circle section is a pillar section with a flat-edge on a circle cross-section.

6. The supporting frame according to claim 1, wherein said non-circle section is a pillar section with a hexagonal cross-section.

7. The supporting frame according to claim 1, wherein said male portion comprises a protruding key, and said female portion comprises keyway to fit said protruding key.

8. The supporting frame according to claim 1, wherein said female portion further comprises a screw stop, so as to press said female portion and fix tightly when said male portion mating together with said female portion.

9. The supporting frame according to claim 1, wherein said male portion is a pillar section having a key hole therein, and said female portion has a perforated hole therein, and said perforated hole corresponds to said key hole so as to form a key way to provide a key pin to pass when said female portion are female conjoining with said male portion.
